(19) United States
(12) Patent Application Publication
(10) Pub. No.: US 2017/0280681 A1
(43) Pub. Date: Oct. 5, 2017

(54) Animal Protective Recovery Collar and Neck Piece

(71) Applicant: Jill Jurgens, Auburn, WA (US)

(72) Inventor: Jill Jurgens, Auburn, WA (US)

(21) Appl. No.: 15/476,777

(22) Filed: Mar. 31, 2017

Related U.S. Application Data
(60) Provisional application No. 62/316,583, filed on Apr. 1, 2016.

(51) Int. Cl. A01K 13/00; A01K 27/00; A01K 15/04

(52) U.S. Cl. CPC A01K 13/006; A01K 15/04; A01K 27/001

(57) ABSTRACT

A protective recovery cone collar for the head of an animal having a protective cone body with a first and a second opening, the first opening having a smaller size than the second opening. The protective recovery cone body includes an exterior textile layer, an interfacing layer coupled to the exterior textile layer, a cushioning layer coupled to the interfacing layer, and an interior textile layer coupled to the interfacing layer. The protective recovery cone collar includes a neck piece attached to the protective cone body having an exterior fabric layer, an interior cushioning layer coupled to the exterior fabric layer, and an interior elastic layer within the interior cushioning layer. Water-absorbent beads may further be included within an interior of the neck piece.

### CROSS-REFERENCE TO RELATED APPLICATIONS

The present application is a nonprovisional application which claims the benefit of U.S. Provisional Patent Application No. 62/316,583 filed on Apr. 1, 2016, entitled “Animal Protective Recovery Collar and Neck Piece,” which is incorporated herein by reference in its entirety as if fully set forth herein.

### FIELD OF THE DISCLOSURE

This disclosure relates generally to the field of protective animal collars. More specifically, this disclosure relates to an animal recovery cone collar having an attachable padded neck piece, whereby the animal recovery collar may be worn temporarily to prevent an animal from scratching its face, as well as to prevent an animal from licking or biting sensitive areas of the animal's body.

### BACKGROUND

Maintaining the health of one's household pet is very important to many families and pet owners in general. Proper medical care and attention sometimes requires a visit to a veterinarian or other animal medical clinic to undergo surgery or other medical related procedures for a medical condition or injury a pet may have. During the recovery period, it becomes imperative that the household pet is prevented from accessing the affected, sensitive area on its body where the medical wound, stitches, medicine, sores, or injury is located.

It is basic instinct for pets to attempt to scratch or bite at themselves using one or more of their legs, teeth, or other items. It is also basic instinct for pets to attempt to groom and wash their bodies by licking themselves. Unfortunately, such behavior is detrimental to the healing process of an affected area on the body of a pet (or other animal), because by touching the affected area with either its mouth, including its tongue or teeth, or using any of its legs or paws, the pet may potentially remove any stitches that were put in place, as well as cause harmful bacteria and germs to occur at the site of the affected, sensitive area of concern on the pet's body.

Collars exist that prevent a pet from accessing a certain area of its body, that are temporarily secured around the head of an animal, and ultimately, prevent a pet from bending its neck or reaching around. Such collars are often called “Elizabethan collars” or “E-Collars.” There are multiple examples of medical collars that are generally circular shaped pillows that have an opening through the middle of the circular pillow for an animal's head and neck to protrude through. Other conventional forms of protective animal collars are known as “Cone Collars”, which are very rigid cone-shaped collars that may be attached to a regular collar worn by the pet, and are wider around the head of the animal, and narrows towards the neck or base of an animal's head, thus preventing the pet from turning and reaching its body extremities with any part of its mouth. Previously filed patents exist that describe various types of cone collars or E-Collars, but they do not suffice in their recommended embodiments to overcome the on-going problems with available cone collars. For example, while U.S. Pat. No. 8,181,609 describes a cone collar, there is no means of tightening the collar to adapt to the different sizes of either the heads or necks of the animals that may be wearing the cone collar. Further, the fiber cloth cone collar described in U.S. Pat. No. 8,181,609 does not provide sufficient firmness to keep the cone collar upright when worn by an animal, thus negating the basic function of the cone collar. In addition, U.S. Pat. No. 5,012,764 also describes a cone collar, but one that would cause discomfort to an animal in the form of chaffing and overtightening, because the rigid cone collar is fitted directly around an animal's neck without any other barrier to provide padding or cushioning. U.S. Pat. No. 8,720,386 describes another variation of a cone collar having stays, but must be separately fitted to a conventional collar using a ribbon or string, which is often a time consuming, cumbersome process for pet owners.

Despite the various designs and types of E-Collars that are presently available, there still exist numerous drawbacks and problems that have not been addressed by the presently available options. For example, most E-Collars are not designed to provide a sense of security or comfort to an animal. It is common to find that an existing E-collar is overly stiff and rigid, causing the animal to be excessively uncomfortable when wearing such a hard E-collar. Further, regular, everyday movement and activity, including sleeping, eating, or drinking, becomes very difficult for the animal. While there are some E-Collars that profess to be softer and more flexible, these E-Collars are not designed well and are easily removed by an animal, thus failing at their initial purpose and function. In addition to the above-mentioned drawbacks, conventional E-Collars are difficult to put in place and difficult to remove, lack proper ventilation, are not suitable in the summer or when the animal is shedding, thus causing an animal to overheat, impair the pet's vision, and also do not fit properly around the neck and head of the pet.

Indeed, most pet owners dread the whole process of enforcing that their pet wear any of the existing E-Collars for any period of time. Thus, due to the struggle pet owners face in finding an E-Collar suitable for their pets, there is still a long-felt need for a properly functioning, yet comfortable and versatile E-Collar.

### SUMMARY

The disclosure presented herein relates to embodiments for a protective animal recovery cone collar. In one or more embodiments, a protective recovery cone collar may include protective cone body having a first and a second opening. The first opening may have a smaller size than the second opening. The protective cone body may further include an exterior textile layer, an interfacing layer coupled to the exterior textile layer, a cushioning layer coupled to the interfacing layer, and an interior textile layer coupled to the interfacing layer.

In another aspect, embodiments provided in the present description may relate to a protective recovery cone collar that may protect the head of an animal that may include an attachable neck piece. In one or more embodiments, a protective cone body may have a first and a second opening. The first opening may have a first opening having a smaller size than the second opening. The protective cone collar may further include an exterior textile layer, an interfacing layer coupled to the exterior textile layer, a cushioning layer coupled the interfacing layer, and an interior textile layer coupled to the interfacing layer. In addition, the protective recovery cone collar may include a neck piece attached to the protective cone body. The attachable neck piece may include an exterior fabric layer, an interior cushioning layer coupled to the exterior fabric layer, and an interior elastic layer within the interior cushioning layer.

In yet another aspect, embodiments provided in the present description may relate to a protective covering for the head of an animal, having an attachable neck piece that may further include water absorbent beads. In one or more embodiments, a protective covering may include a protective cone body with a first and a second opening, the first opening having a smaller size than the second opening. The protective cone body may further include an exterior textile layer, an interfacing layer attached to the exterior textile layer, a cushioning layer attached to the interfacing layer, and an interior textile layer attached to the interfacing layer. In addition, the protective covering may include a neck piece removably attached to the protective cone body, whereby the neck piece includes an exterior fabric layer, an interior cushioning layer attached to the exterior fabric layer, an interior elastic layer within the interior cushioning layer. Further, water absorbent beads may be located within the interior of the neck piece that are configured to absorb and then slowly release water, thus cooling an animal.

The preceding and following embodiments and descriptions are for illustrative purposes only and are not intended to limit the scope of this disclosure. Other aspects and advantages of this disclosure will become apparent from the following detailed description.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 shows a front view of an exterior facing side of a recovery cone collar having an attached neck piece in accordance with an illustrative embodiment.

FIG. 2 shows a front view of an interior facing side of the recovery cone collar of FIG. 1 in accordance with an illustrative embodiment.

FIG. 3 shows a sectional view of a cone portion of a recovery cone collar in accordance with an illustrative embodiment.

FIG. 4 shows a sectional view of a neck piece in accordance with an illustrative embodiment.

FIG. 5 shows a sectional view of the neck piece of FIG. 4 in accordance with an illustrative embodiment.

FIG. 6 shows a front side view of an animal wearing a recovery cone collar in accordance with an illustrative embodiment.

FIG. 7 shows a rear view of an animal wearing a recovery cone collar in accordance with an illustrative embodiment.

FIG. 8A shows an embodiment of a recovery cone collar that includes water absorbent beads in a detachable neck piece in accordance with an illustrative embodiment.

FIG. 8B shows an embodiment of the detachable neck piece of FIG. 8A submerged in water in accordance with an illustrative embodiment.

FIG. 9 shows an alternative embodiment of a recovery cone collar in accordance with an illustrative embodiment.

FIG. 10 shows another alternative embodiment of a recovery cone collar in accordance with an illustrative embodiment.

FIG. 11A shows an exterior view of a recovery cone collar having a removable panel in accordance with an illustrative embodiment.

FIG. 11B shows an exterior view of the removable panel of FIG. 11A detached from a recovery cone collar in accordance with an illustrative embodiment.

FIG. 11C shows an exterior view of the removable panel of FIG. 11A and FIG.11B in accordance with an illustrative embodiment.

FIG. 12 shows a recovery cone collar having a light band and battery pack included in accordance with an illustrative embodiment.

### DEFINITIONS

As used in the present disclosure, the following terms are to be attributed the meanings assigned in this section and listed below:

Set as used herein, may refer to one or more items.

Interior is defined as a view of a side of the recovery cone collar that, when properly oriented, is facing either a front or back of an animal's neck and head.

Exterior is defined a view of a side of the recovery cone collar that faces away from either the front or back of an animal's head and neck.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Throughout the drawings, like reference characters are used to designate like elements. Further, the drawings are not to scale and depicted components or structures may have dimensions other than those depicted or perceived in the drawings.

As used herein, the term “coupled” or “coupling” may indicate a connection. The connection may be a direct or an indirection connection between one or more items. Further, the term “set” as used herein may denote one or more of any item.

The different illustrative embodiments recognize and take into account a number of different considerations. Pet owners (as well as other users) greatly value the comfort and well-being of their household pets. It is desirable for those to have struggled with conventional protective collars, to use a protective collar that is both comfortable and well-designed, but also be sturdy enough and securely fastened to be held in place to prevent an animal from licking or biting certain sensitive areas of concern on an animal's body. Due the lack of suitable alternatives, the present disclosure is provided, which includes one or more such innovative embodiments.

As disclosed herein, one or more embodiments in the present disclosure are directed to an animal protective recovery collar. One or more embodiments provided herein includes a collar body that is configured to be shaped into a cone that may be fitted around the head of an animal. In one or more embodiments, the collar body may include several layers of varying materials that provide a balance between adequate rigidity and flexibility for the structure of the recovery collar. Additionally, one or more embodiments provided in the present disclosure may include a firm interface that is coupled to opposing layers of fabric. In one or more embodiments, an additional layer of cushioning (e.g. batting) may be located between one side of the interfacing and the adjoining layer of fabric. Further, as disclosed herein, one or more embodiments of a protective recovery cone collar, described herein, may further include a supportive neck piece that is coupled to the upper collar body. In one or more embodiments, the collar body and the coupled neck piece may each include a number of fasteners separately located on each piece, so that the collar body and the coupled neck piece may be tightened independently of each other. Beneficially, the collar body and the coupled neck piece may also be tightened and adjusted to accommodate the neck and head of different-sized animals using the various fasteners located on the collar body and the neck piece.

In addition, as shown in the accompanying Figures, the neck piece may be padded and include an elastic band that will advantageously fit more comfortably around the neck of an animal, thereby reducing the risk of choking an animal by over tightening the neck piece. Further, one or more embodiments of the present disclosure may include detachable neck pieces that include additional structural elements, including, without limitation, water-absorbing beads that help cool an animal. Additional detail is provided below regarding one or more embodiments of the present description.

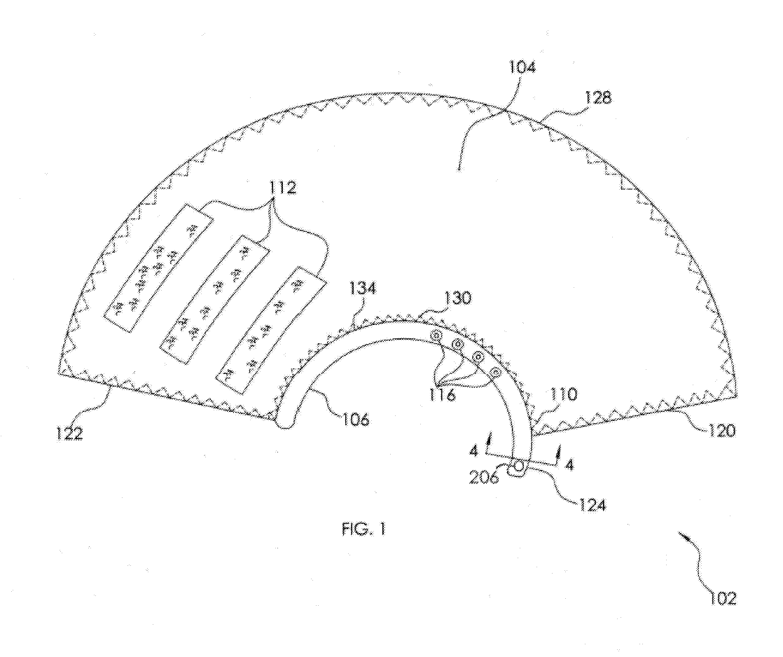

FIG. 1 shows a front side view of an exterior of a recovery cone collar having an attached neck piece according to one or more embodiments of the present disclosure. In one or more embodiments, the body of recovery cone collar 102, as shown in FIG. 1, includes cone portion 104 and an attached neck piece 106. Recovery cone collar 102 is useful as a protective medical or restraint collar for animals. Recovery cone collar 102 may be worn by any animal, including without limitation, household pets, such as cats, dogs, or birds.

FIG. 1 shows a flat view of cone portion 104 and neck piece 106 and illustrates the recovery cone collar 102, as a whole, in its unassembled state. As shown in FIG. 1, in its unassembled state, cone portion 104 and neck piece 106 are open and their edges are not secured using the one or more closures located on either cone portion 104 or neck piece 106 (e.g. hook and loop fasteners 112 and snaps 116). Thus, in its unassembled state, recovery cone collar 102 does not encircle an animal's head or neck.

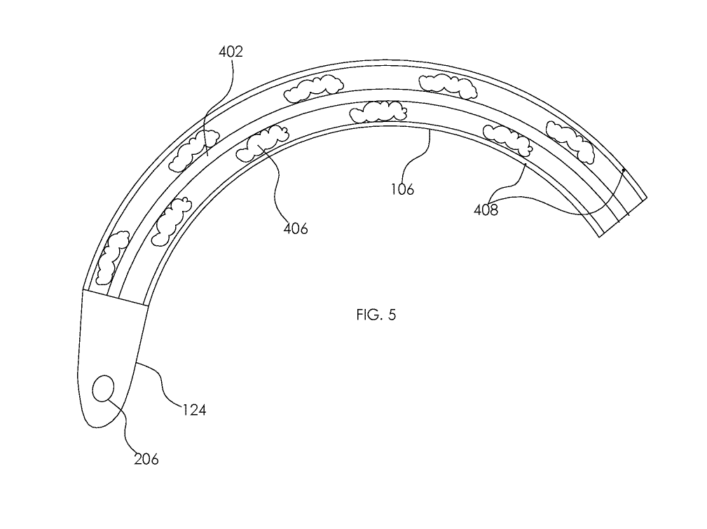

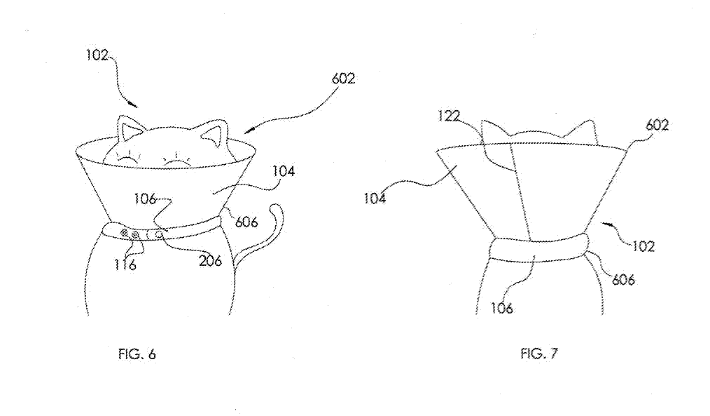

In its unassembled state, cone portion 104 is flat and generally arch-shaped. In an embodiment, cone portion 104 includes at least one concentric circular arc. Accordingly, cone portion 104 in FIG. 1 includes outer arch 128 and inner arch 130. Further, as shown in FIG.1, cone portion 104 may include first end 120 and second end 122. First end 120 and second end 122 extend between and connect inside arch 130 to outside arch 128 of cone portion 104. When cone portion 104 is in its assembled state as detailed below, cone portion 104 forms a truncated cone as shown in FIG. 6 and FIG. 7.

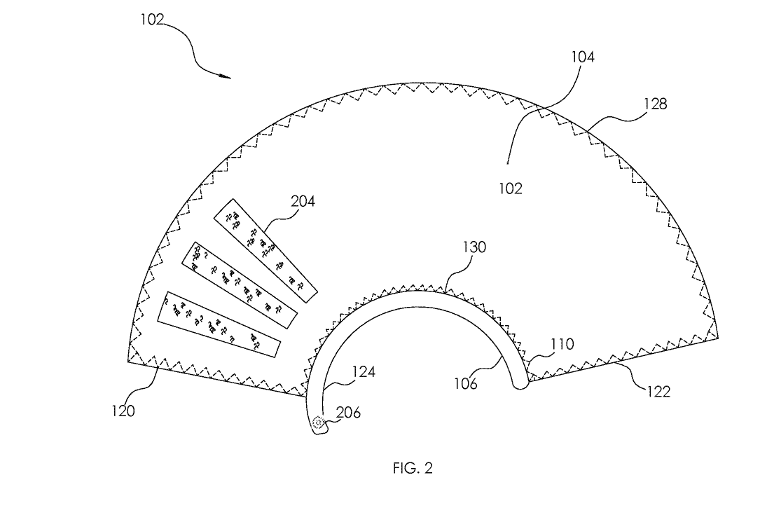

In an exemplary, non-limiting embodiment, one or more fasteners may be distributed along the exterior of recovery collar 102. Any suitable fasteners known in the art or yet to be developed may be utilized on the exterior or interior as shown in FIG. 2 of recovery collar 102. In one non-limiting example shown in FIG. 1, hook and loop fasteners, such as hook and loop fasteners 112 are used. VELCRO is a well-known brand and manufacturer of hook and loop fasteners, and may be used for hook and loop fasteners 112 and their mating strips 204.

FIG. 2 shows an interior view of recovery cone collar 102. As previously discussed, an interior view of recover cone collar 102, when properly oriented, directly faces an animal's face and neck. In one or more embodiments, the corresponding mating strips 204 of hook and loop fasteners 112 may be located on an interior of recovery cone collar 102. Mating strips 204 are also hook and loop fasteners, such as hook and loop fasteners 112, but include corresponding elements on an outer surface of mating strips 204 that function to mate with the elements located on the outer surface of hook and loop fasteners 112. Hook and loop fasteners 112 and mating strips 204 may conveniently be fastened and unfastened numerous times as needed. Those of ordinary skill in the art will appreciate that hook and loop fasteners 112 and mating strips 204 may be cut to any length and size, and may come in multiple colors and materials.

It is noted that, in one or more embodiments, mating strips 204 are located on a reverse side of recovery cone collar 102, and further, are located proximate to an opposite end of hook and loop fasteners 112 (e.g. first end 120). When first end 120 is brought towards second end 122 of cone portion 104, mating strips 204 may be connected with hook and loop fasteners 112, thus forming a cone shape out of cone portion 104.

As shown in FIG. 1 and FIG. 2, recovery cone collar 102 may include at least three hook and loop eye fasteners 112 and three corresponding mating strips 204. Alternatively, any number of hook and loop fasteners 112 and their corresponding mating strips 204 may be used. While the hook and loop fasteners 112 and mating strips 204 are shown arranged in a horizontal orientation and located in an ascending manner (e.g. one above the other), in alternative embodiments, hook and loop fasteners 112 may be arranged in a vertical orientation. In yet another alternative, hook and loop fasteners 112 and mating strips 204 may be oriented in an angled manner. Further, in one or more embodiments (not shown), hook and loop fasteners 112 may be oriented in a horizontal orientation and the mating strips 204 may be oriented in a vertical orientation, or vice-versa.

Advantageously, a pet owner is enabled using the above-mentioned embodiment of recovery cone collar 102 to adjust the sizing of cone collar 104 to properly fit around an animal's head. In other words, pet owners may customize the sizing of cone collar 104 to best fit an animal's head. For example, the cone portion 104 may be made smaller or larger, to best fit an animal's head by adjusting the placement of hook and loop fasteners 112, respectively, along the length of mating strips 204, or vice versa. Further, having the ability to adjust the size of cone portion 104 to increase visibility for the designated animal helps to reduce any anxiety or discomfort an animal may feel when wearing recovery collar cone 102.

In one or more embodiments, neck piece 106 (shown in FIG. 1 and FIG. 2) is a supportive neck piece that is coupled to cone portion 104 of recovery cone collar 102. In one or more embodiments, neck piece 106 may be securely attached to cone portion. For example, neck piece 106 may be connected by sewing an outer surface of neck piece 106 to inner arch 130 of cone portion 104. As shown in FIG. 1 and FIG. 2, stitches 110 are located along the outer edges of outer arch 128, along inner arch 130, as well as along first end 120 and second end 122 to indicate that one or more layers of cone portion 104 (as will be discussed in detail below) may be sewn together.

Neck piece 106 functions as a replacement collar to traditional collars worn by household pets or other animals. Conventional cone collars are usually attached with a ribbon or through attached loops to a conventional collar, which makes positioning such cone collars difficult and time consuming to place on a pet, especially for individuals who have limited dexterity in their hands and fingers. Advantageously, neck piece 106 may enable a pet owner to directly position recovery cone collar 102 around a neck of an animal with greater ease and precision. Neck piece 106 may be made of any suitable materials, including cotton, polyester, or any other material known in the art.

In one or more embodiments, neck piece 106 may include fasteners located on an outer surface of neck piece 106. As shown in FIG. 1., fasteners 116 are located on neck piece 106. Any suitable fasteners may be used as known in the art. In one embodiment, fasteners 116 may be snaps, which usually a stud and/or post that may be coupled with a corresponding snap cap (e.g. snap cap 206 shown in FIG. 2), stud, and post. As shown in FIG. 1, there may be multiple fasteners 116 located along neck piece 106. Any number of fasteners 116 may be used, although FIG. 1 shows an exemplary embodiment whereby neck piece 106 includes four fasteners 116.

Neck piece 106 may include an extended piece 124 which is not secured to cone portion 104. Extended piece 124 extends past an end (e.g. first end 120) of cone portion 104, and may include a snap cap (e.g. snap cap 206 as shown in FIG. 2) for connecting to the corresponding posts and studs (e.g. 116) located on neck piece 106. Accordingly, in one or more embodiments, an exterior view of recovery cone collar 102, as shown in FIG. 1, neck piece 106 may include a set of female snap connectors, such as snaps 116, and the top of the snap cap 206. Conversely, on a reverse side, i.e. on the interior side of recovery cone collar 102, in one or more embodiments, neck piece 106 may include the male connector member of the snaps used to fasten close the neck piece, such as snap cap 206. As shown in FIG. 1 and FIG. 2, and throughout other Figures, female connector snap members 116 may include an opening for receiving a post located on a male connector of snap cap 206 in order for the two to be mateingly fastened together. Further, extended piece 124 is a piece either formed with the rest of neck piece 106 or attached to neck piece 106 that provides additional material on neck piece 106, and may be useful to reach around the neck of an animal to fasten shut neck piece 106. Accordingly, a pet owner is enabled to size neck piece 106 to adjust to the size of their animal's neck by positioning snap cover 206 over any of the female connector snaps 116. Beneficially, both cone portion 104 and neck piece 106 may be independently tightened and adjusted to best accommodate the size of an animal's neck and head as needed.

It is noted that, as an alternative to fasteners 116 and (snap cap 206), or in addition to, there may be other types of fasteners on neck piece 106, including, without limitation, buttons, buckles, or any other type of fastener. Further, hook and loop tape or other fasteners may be located on neck piece 106, and/or extended portion 124.

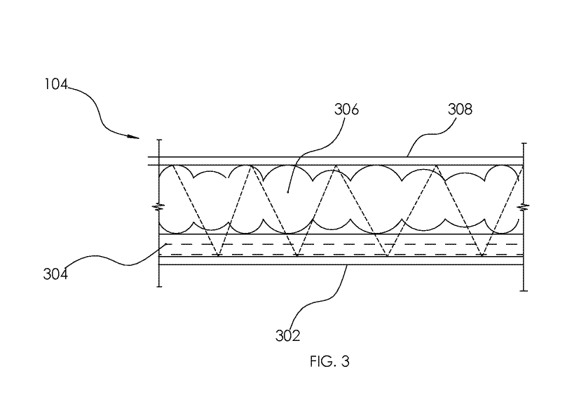

Turning to FIG. 3, FIG. 3 shows a cross-sectional view of cone portion 104 of recovery cone collar 102. In one or more embodiments, cone portion 104 may be an assembly of multiple layers. As shown in FIG. 3, cone portion 104 may include an exterior textile layer 302 and an interior textile layer 308. In one or more embodiments, interior textile layer 308 is a side of cone portion 104 that faces towards the animal's head and neck when recovery cone collar 102 is worn. Conversely, exterior textile layer 302 faces away from the animal's head and neck when recovery cone collar 102 is worn.

Exterior textile layer 302 and interior textile layer 308 may be fabric that is made of any suitable material known in the art, including without limitation thereto, cotton. To increase the aesthetic appeal of cone portion 104 and recovery cone collar 102 as a whole, exterior textile layer 302 and interior textile layer 308 may include bright, cheerful patterns, with different patterns or designs for either exterior textile layer 302, interior textile layer 302, or both. Exterior textile layer 302 and interior textile layer 308 may include any design, patterns, and color combinations. Optionally, there may also be one or more decorative elements included on either exterior textile layer 302 or interior textile layer 308. Such decorative elements may include, without limitation, alphabetical or numerical letters sewn into the textiles (e.g. monogramming), decorative bows, beads, glitter elements, or any other suitable decorative elements. Alternatively, either exterior textile layer 302 or interior textile layer 308, or both, may be composed of a solid, single color and have a uniform appearance.

Further, in one or more embodiments of recovery cone collar 102, the material used for interior textile layer 308 may have a quilted or “quilt-like” appearance, meaning that the outside surface of interior textile layer 308 may include any number of shapes that would be seen on a quilt (e.g. diamond, circles, squares, etc.) with visible stitches surrounding the shapes. Having a quilted appearance on the outside surface of interior textile layer 308 may provide a more visually appealing look to cone portion 104 as well as give the wearer and pet owner a greater sense of comfort reminiscent of the sensation when covering with a quilt. Indeed, in one or more embodiments, it may be beneficial that the design of the fabric for interior textile layer 308 be a uniform, solid, calming color so as not to make an animal anxious or distracted by too many patterns or colors within the line of sight of an animal.

Cone portion 104 may include additional layers in between exterior textile layer 302 and interior textile layer 308. In one or more embodiments, there may be an interfacing layer, such as interface 304 included in the body of cone portion 104 or recovery cone collar 102. Interface 304 may be attached to (e.g. via adhesive, sewing, fasteners, or any other attachment method known in the art) to an interior side of exterior textile layer 302. Interface 304 may function as a stabilizing and stiffening structural support member for cone portion 104. In other words, interface 304 may aid to keep cone portion 104 firmly upright when cone portion 104 is assembled and secured in a cone shape around the head of an animal. Interface 304 may be made from any suitable material known in the art, including, without limitation, plastic, cardboard, or a combination thereof.

In one or more embodiments, interface 304 may comprise an interfacing material that is manufactured by PELLON, and is known as PELTEX72F or PELLON 72F (hereinafter referred to throughout the present description as PELLON 72F). This interfacing material is known for being a heavy-weight, ultra-firm stabilizer. PELLON 72 is made of polyester, may be obtained in sheet form, and may be connected to other layers or materials. PELLON 72F is a two-sided, fusible interface that includes adhesive material on either side of a sheet of PELLON 72F and may be permanently adhered to other textiles on both sides of a sheet of PELLON 72. PELLON 72 may have a similar level of firmness as a thin cardboard. Those of ordinary skill in the art will appreciate that other forms of heavy-weight, ultra-firm stabilizers may be utilized and may be composed of any type of materials, including, but not limited to, plastics, foam, cardboard, or a combination thereof. Nevertheless, there are advantages in using an interface, such as PELLON 72F, because PELLON 72F provides a firm, stable support structure for cone portion 104, without being overly rigid or too heavy for an animal to support.

In addition to the above, in one or more embodiments, there may be an additional layer located in between interior textile layer 308 and interface layer 304. Cushioning layer 306 may be located between interior textile layer 308 and interface layer 304. Cushioning layer 306 may include softer, padding material that provides additional softness and cushioning to the cone portion 104 of recovery cone collar 102. In one or more embodiments, cushioning layer 306 may include batting, which is useful for padding or insulating items made with fabric. Batting used for cushioning layer 306 may be made from any suitable material, including without limitation, cotton, wool, or polyester, or a combination thereof.

Cushioning layer 306 may be of any suitable thickness. As known in the art, the term “loft' is used to describe the thickness of batting, with low loft batting being a very thin type of batting and high loft or extra loft batting being the thickest. In one embodiment, cushioning layer 306 may be made with high loft or extra loft batting. Beneficially, high loft or extra loft batting, when used as cushioning layer 306, may provide for quilting details and designs to be better seen in detail, and adds additional softness to the cone portion 104 of recovery collar 102. Further, in one embodiment, cushioning layer 306 may be batting that is primarily made of polyester, because polyester batting may be lighter weight, mold resistant, and less expensive than cotton batting (although other materials may certainly be used).

In addition to using varying lofts of batting for cushioning layer 306, in one or more alternative embodiments, there may be multiple cushioning layers 306 (i.e. more than one cushioning layer) located between interior textile layer 308 and cushioning layer 306. It may be useful to have additional layers of cushioning, or even additional thickness of batting used in order to provide additional warmth during winter months or in colder climates. Beneficially, adding additional layers of batting or additional thickness of batting would not add a great deal of weight to recovery cone collar 102, and would not sacrifice the comfortability level for an animal wearing a recovery cone collar 102 with the additional cushioning provided.

While FIG. 3 shows cushioning layer 306 located between interface 304 and interior textile layer 308, in alternative embodiments, there may be a cushioning layer, such as cushioning layer 306 located between interface 304 and exterior textile layer 302 as well.

In one or more embodiments, an exterior surface of interior textile layer 308 may be coupled to cushioning layer 306. Cushioning layer 306 may be coupled to one side of the intermediate interface 304. Subsequently, the reverse side of interface 304 may be coupled to an interior surface of exterior textile layer 302. Any method of adjoining and/or attaching, as known in the art, may be used to connect or attach each of the layers mentioned above to the other. In one or more embodiments, the layers may be attached using any kind of adhesives, fasteners, or any other suitable means of attachment.

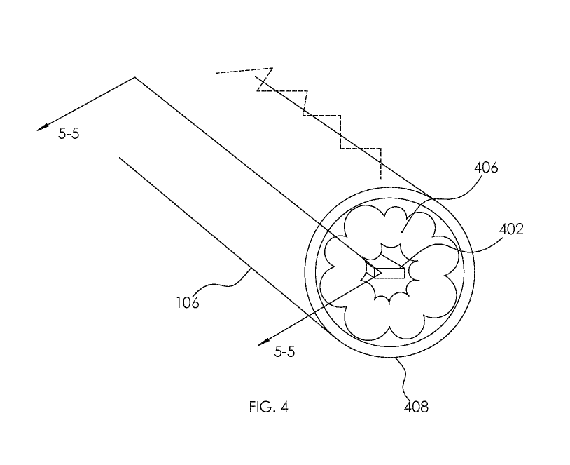

In one embodiment, the exterior textile layer 302, interface layer 304, cushioning layer 306, and interior textile layer 308 may be joined together using one or more sewing techniques (whether by hand or machine). For example, cushioning layer 306 may be coupled to the interface layer 304 using one or more sewing techniques, such that cushioning layer 306 is sewn to interface layer 304, and is also sewn to interior textile layer 308. As shown in FIG. 1 and FIG. 2, stitches 110 may be placed (e.g. via sewing) around all or a portion of the perimeter of cone portion 104. Further, a number of stitches, such as stitches 110, may be used to join textile 408 (as shown in FIG. 4) of neck piece 106 with cone portion 104 (as shown in FIG. 1 and FIG. 2). Using stitches 110 in one or more embodiments to join the layers and members of recovery cone collar 102, may provide a cone collar that evokes a handcrafted, comfortable, and aesthetically appealing look. In addition, an animal wearing recovery cone collar 102 having a number of stitches 110 around its perimeter and along the seam with neck piece 106, will avoid having any encumbrances that may result from using zippers, buttons, or other metal or plastic fasteners. Nevertheless, it is well within the scope of the present disclosure that in alternative embodiments, fasteners, including, but not limited to, metal or plastic-type fasteners, may be used to join the multiple layers (e.g. 302-308) of cone portion 104 together or to connect neck piece 106 to cone portion 104 instead of stitches 110. Any suitable means of attachment may be used, including, but not limited to, using adhesives and/or VELCRO.

Further, in one or more embodiments, corset boning or sewing boning may be added to cone portion 104. The corset boning may be any type of corset boning known in the art, and any number as desired may be attached to the interface layer 304. Having the corset boning, particularly for the larger sized recovery cone collars 102 (e.g. for larger animals or pets), may provide additional support and firmness, without sacrificing the desired flexibility of cone portion 104 of recovery cone collar 102. Thus, corset boning may help to keep cone portion 104 upright.

Using one or more embodiments described above, a cone portion 104 of recovery cone collar 102, as discovered herein, is light-weight and provides comfort to the animal that wears recovery cone collar 102, while also being firm and stable enough to fulfill the basic purpose of a protective medical collar, which is to prevent the animal from scratching its face or bending its head or neck towards the rear of its body and licking, biting, or scratching affected areas of concern on its body. Everyday activities that an animal engages in, such as, eating, drinking, sleeping, playing, are not encumbered by the firm, yet flexible structure of one or more embodiments of recovery cone collar 102.

In addition, it is noted that one or more embodiments of recovery cone collar 102 having neck piece 106 may not be easily removed or disengaged by an animal, unlike other conventional protective animal medical collars. Based on experimental tests conducted on exemplary embodiments similar to those discussed in the present disclosure for recovery cone collar 102, an average of 4.8-5.9 pounds of force may be needed to remove or “break away” recovery cone collar 102, which is greater than many existing medical collars for animals. Beneficially, recovery cone collar 102, including cone portion 104 and neck piece 106, is secured in a manner that it is not easily removable by most animals, but is not overly restrictive either. Thus, a user is able to rely that recovery cone collar 102 may remain in place to protect their animal and prevent their animal from scratching, licking, or biting sensitive areas of their face and/or body.

Turning to FIG. 4, FIG. 4 shows a cross-sectional view, taken along section line 4-4 shown in FIG. 1, of a neck piece of recovery cone collar 102 according to one or more embodiments disclosed herein. In an exemplary, non-limiting embodiment, neck piece 106 may include a stretchable, elastic band, such as elastic band 402 shown in FIG. 4. Encapsulating elastic band 402, there may be an additional layer of cushioning or padding, such as neck piece cushioning layer 406. In one or more embodiments, neck piece cushioning layer 406 may be made of batting, as described above. Accordingly, any type of material or thickness of batting may be used as desired for neck piece cushioning layer 406. In addition to the above, an outer layer of textile, or fabric, such as textile 408 may cover neck piece cushioning layer 406. Textile 408 may be made of any suitable material known in the art, and may include any type of design, patterns, or combination of colors. Textile 408 may be made of any suitable material known in the art, but it is noted, that in one embodiment, textile 408 may be made of cotton to provide a cooler, lightweight fabric useful in summer and warmer climates. As well, cotton fabric may be useful for preventing itchiness or discomfort to the animal wearing neck piece 106 with cone portion 104.

FIG. 5 shows a sectional view of the neck piece 106 as shown in FIG. 4, taken along section line 5.5. In one or more embodiments, as shown in FIG. 5, neck piece 106 may be in the form of a semi-circular band when unassembled and unsecured, and may contain elastic band 402, which is encircled by a layer of cushioning, i.e. neck piece cushioning layer 406. As also shown in FIG. 1, neck piece 106 may include extended piece 124 which provides additional material that can reach around the neck of an animal to fasten shut neck piece 106 (e.g. via snap cap 206).

Advantageously, neck piece 106 may provide additional comfort and ease of use to a user when attempting to fasten recovery cone collar 102 around the head and neck of an animal. The additional layer of padding and cushioning (e.g. 406) provides greater softness and comfort to the animal. Further, elastic band 402 provides flexibility to the structure of neck piece 106 such that neck piece 106 may be stretched to best fit around the neck of an animal. In addition, having elastic band 402 prevents choking or over tightening of neck piece 106 around a neck of an animal.

FIG. 6 shows a front side view of an animal wearing a recovery cone collar having an attached neck piece, such as recovery cone collar 102, in accordance with one or more embodiments. FIG. 7 shows a reverse side view of an animal wearing recovery cone collar 102 in accordance with one or more embodiments. As shown in FIG. 6, recovery cone collar 102 when worn, provides a protective medical collar or veterinary restraint collar encircling the head and neck of an animal. While FIG. 6 and FIG. 7 show a cat as an exemplary animal that may wear recovery cone collar 102, it is to be understood that any type of household pet or animal may utilize recover cone collar 102.

As shown in FIG. 6, neck piece 106 may be placed and fastened directly around a neck of an animal. Depending on the fastener selected by a user (e.g. pet owner), there may be some remaining fasteners, such as fasteners 116 shown in FIG. 6, that remain visible after neck piece 106 has been secured in place. Cone portion 104 of recovery cone collar 102, when assembled, may include a first opening 602 and a second opening 606 as shown in FIG. 6. When assembled, cone portion 104 of recovery cone collar 106 may appear to be a truncated cone. As known in the art, the general shape of cone portion 104, when assembled around the head of an animal, is generally a frusto-conical shape, whereby a frusto-conical shape is a cone whose tip has been truncated by a plane parallel to its base.

First opening 602 is located towards to the top of cone portion 104 and second opening 606 is located towards the bottom of cone portion 104 when cone portion 104 is fully assembled or fastened together (e.g. using hook and loop eye fasteners 112 shown in FIG. 1 and mating strips 204 shown in FIG. 2).

In order to fit a recovery cone collar, such as recovery cone collar 102 around the neck and head of animal, one or more steps as presented below may be followed. First, a user may orient recovery cone collar 102 such that the exterior side will face away from the animal and the interior side of recover cone collar faces towards or against the animal. Once properly oriented, a user may locate neck piece 106 (attached to cone portion 104) against a base of the animal's neck. In accordance with one or more embodiments, when neck piece 106 includes elastic band 402, neck piece 106 may be stretched to fit comfortably around the neck of an animal. Subsequently, by taking hold of extended piece 124, in accordance with one exemplary, non-limiting embodiment, the outer snap cover 206 located on extending piece 124 may be securely fastened against a corresponding base snap piece 116. It is up to the user to decide which base snap piece 116 to secure the outer snap cover 206, thus enabling the pet owner to customize the size of neck piece 106 to the neck of his or her animal. Thus, neck piece 106 may be held in place against the neck of an animal. As previously discussed, alternative fasteners (e.g. buckles, clips, VELCRO, etc.) or other attachment methods as known in the art may be used to fasten neck piece 106.

Once neck piece is fastened, it may be desirable to fasten cone portion 104 of recovery cone collar 102 in place. In accordance with one or more non-limiting embodiments, a user may bring the first end 120 of cone portion 104 around the head of the animal towards second end 122, and affix mating strips 204 in the desired placement and arrangement to best suit the size of the animal's head against hook and loop tape fasteners 112. FIG. 7 shows the joint line where second end 122 overlaps first end 120, once the two ends have been brought towards one another to fasten shut cone portion 104. Those of ordinary skill in the art will appreciate that alternative methods of fastening cone portion 104 may be used, and all such methods are within the scope of the present disclosure. For example, as an alternative to using hook and loop fasteners 112 and mating strips 204, or in addition, there may be a set of buttons and corresponding button holes located opposite sides of cone portion 104.

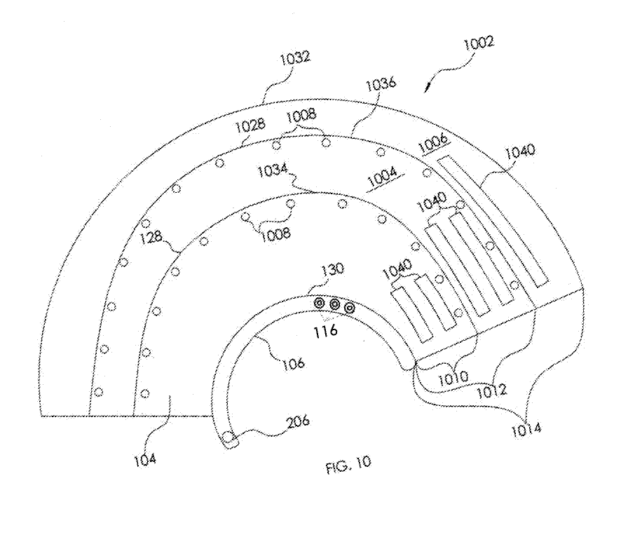

FIG. 6 and FIG. 7 further illustrate that decorative patterns, such as decorative pattern may be included on an exterior textile layer 302 of recovery cone collar 102 to increase the aesthetic appeal of the recover cone collar 102. It is noted that recovery cone collar 102, including cone portion 104 and attached neck piece 106 may be any suitable size or dimension. Further, recovery cone collar 102 may be manufactured in various “sizes”, such as small, medium, and large based on standard neck and head sizes of household pets or other animals. Alternatively, FIG. 10 (as discussed further below) shows an embodiment of a recovery cone collar (e.g. recovery cone collar 1002) that is equivalent in basic form and function as recovery cone collar 102, with the added advantage that the original size of the recovery cone collar 1002 may be altered and expanded by adding one or more structural extensions to the base portion of the recovery cone collar 1002.

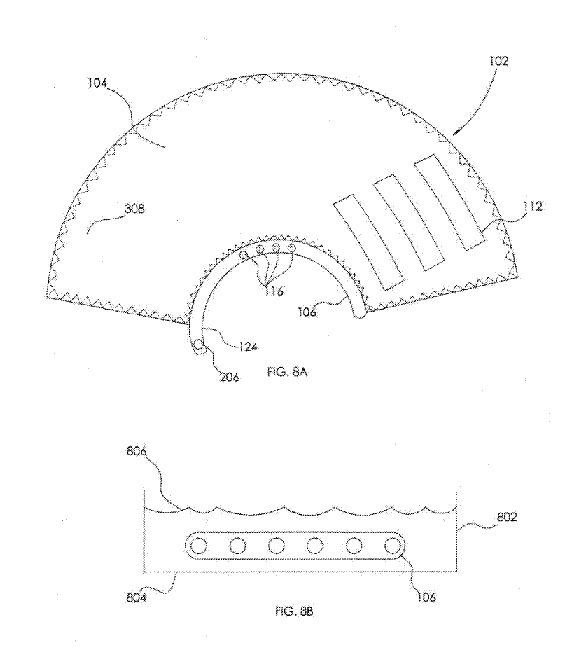

Turning to FIG. 8A, FIG. 8A shows an alternative embodiment of recovery cone collar 102. As shown in FIG. 8A and FIG. 8B, in one or more embodiments, neck piece 106 may be detachable rather than being permanently sewed or otherwise affixed to cone portion 104. Accordingly, neck piece 106 may be removable and then may be reapplied or re-attached as desired by a user. It is noted that FIG. 8A shows an interior side of recovery cone collar 102, such that interior textile layer 308 may be visible.

FIG. 8B shows neck piece 106 located within container 804, which is filled with some amount of water 806. As shown in FIG. 8B, neck piece 106 may further include water absorbing beads 804 located throughout an interior of neck piece 106. Water absorbing beads 804 may be any type of water absorbing beads known in the art, and may be of any desired size or material. In addition to water absorbing beads 804, it is noted that neck piece 106 may also include elastic band 402, neck piece cushioning 406, or both. Further, neck piece 106 and its contents may be made water-proof and mold resistant using one or more methods known in the art.

In one or more embodiments, water absorbing beads 804 may be located throughout cushioning 406 of neck piece 106. Alternatively, water absorbing beads 804 may also be located anywhere in neck piece 106 in alternative embodiments. To prevent the neck piece 106 from being accidentally punctured, in one embodiment, outer textile layer 408 of neck piece 106 may be thickened by using a double layer of textile (e.g. fabric), which helps to prevent rupturing a thin layer of textile 408 and any spillage of water absorbing beads 804.

In one or more embodiments, upon detaching neck piece 106 from the rest of recovery cone collar 102 (i.e. cone portion 104), neck piece 106 may be submerged in water 806 in container 804. As shown in FIG. 8B, the water absorbing beads 804 may then soak up the water 806 from container 804. It is noted that other ways of soaking neck piece 106 with water may be used, including placing under a running faucet, hose, or in any body of water, such as a pool, river, lake, etc. All such methods and alternatives are considered to be within the scope of the present disclosure.

The water absorbing beads 804 may require a minimal amount of time to absorb a sufficient amount of water. Thereafter, the wet neck piece 106 may be reattached to cone portion 104 and fastened around the neck of an animal. Over a period of time, the water absorbed by the water absorbing beads 804 will be released onto the neck and skin of the animal. The embodiment shown in FIG. 8A and 8B of the present disclosure for recovery cone collar 102, and detachable neck piece 106 with the water absorbing beads 804 may be particularly useful for cooling an animal in either the summer or any other occasion when the animal has overheated.

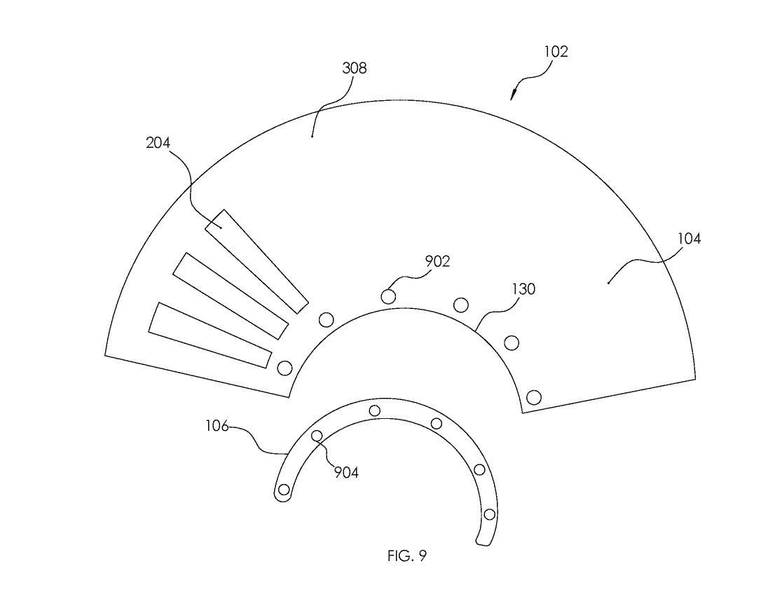

FIG. 9 shows an embodiment for a detachable neck piece, such as neck piece 106. In FIG. 9, a series of buttons 902 are distributed above an inner edge of inner arch 130 of cone portion 104. Conversely, an equal, greater, or lesser number of buttonholes 904 may be arranged on neck piece 106 and extend through the body of neck piece 106, such that buttons 902 located on cone portion 104 may be pushed through the buttonholes 904 located on neck piece 106. Accordingly, neck piece 106 may be detachable using this connection system and method. As desired, a user may choose to button all the buttons 902 or only a portion thereof when connecting neck piece 106 to cone portion 104. Further, it is noted that the neck piece 106 shown in FIG. 9 may also include water absorbing beads, such as water absorbing beads 804, elastic band 402, neck piece cushioning 406, or any combination thereof. Alternatively, one or more zippers may be used to zip and unzip neck piece 106 to an inner edge of inner arch 130 of cone portion 104.

By being removeably connected to cone portion 104, neck piece 106 offers additional versatility and flexibility of use for a pet owner or other user of recovery cone collar 102. In some embodiments, a user may desire to remove neck piece 106 and connect cone portion 104 using some other member around the neck of his or her animal. Further, in the summer or in hotter climates, it may be useful for a user to detach the neck piece 106 from time to time.

FIG. 10 shows an alternative embodiment of a recovery cone collar in accordance with one or more embodiments of the present disclosure. FIG. 10 shows an interior side of recovery cone collar 1002 that faces towards an animal's neck and head. Recovery cone collar 1002 is an embodiment of a protective animal medical collar whose size may be adjustable by adding additional extensions, such as cone collar extension 1004 and cone collar extension 1006 to the base cone portion 104. Cone collar extensions 1004 and 1006 provide the additional structure to expand an original size of a recovery cone collar, such as recovery cone collar 802. Accordingly, recovery cone collar 802 may have an initial diameter, such as initial diameter 1010 (as measured from the outer arch 128 to the inner arch 130 of base cone portion 104), but by attaching cone collar extension 1004 and cone collar extension 1006, the final diameter of recovery cone collar 1002 may be extended to become diameter 1012 or diameter 1014 as desired. Accordingly, a user of recovery cone collar 1002 may optionally vary the size of recovery cone collar 1002 to best suit the dimensions of their animal's head and provide the best fitting cone collar.

Cone collar extension 1004 may be coupled to base cone portion 104, and cone collar extension 1006 may be coupled to cone collar extension 1006 using any connection or attachment means known in the art, including, without limitation, any type of fasteners, adhesives, sewing, or any other suitable method. Various types of fasteners may be used to connect each extension 1004 and 1006 to the rest of recovery cone collar 1002, including, but not limited to, snaps, zippers and/or use of hook and loop fasteners (e.g. VELCRO), or any combination thereof.

FIG. 10 shows an exemplary embodiment of recovery cone collar 1002, whereby a set of buttons, such as buttons 1008 may be used to connect cone collar extension 1004 and 1006 to expand an original size of recovery cone collar 1002. As shown in FIG. 10, a set of buttons, such as set of buttons 1008 may be arranged proximate to an outer perimeter of outer arch 128. Similarly, a set of buttons 1008 may be arranged proximate to an outer perimeter of outer arch 1028 of cone collar extension 1004. It is noted that a greater or lesser number of cone collar extensions, similar to cone collar extensions 1004 and 1006, may be used than the number shown in FIG. 10. If another cone collar extension were to be added to cone collar extension 1006, a set of buttons, similar to set of buttons 1008 may then be arranged as needed along an outer perimeter of outer arch 1032.

In order to connect base portion 104 and cone extension 1004 to another extension, a set of button holes (not shown in FIG. 10) may also be arranged along a lower perimeter 1034 of cone collar extension 1004 and along a lower perimeter 1036 of cone collar extension 1006. The location and placement of the set of button holes on cone collar extension 1004 and cone collar extension 1006 would correspond to the location and placement of the set of buttons 1008. For example purposes only, and without limitation thereto, base cone portion 104 of recovery cone collar 1002 may have an initial diameter 1010 of 12.5 inches. By adding cone collar extension 1004, the diameter 1012 may become 15 inches. By subsequently adding cone collar extension 1006, the diameter 1014 may then become 20 inches. It is noted that other dimensions and diameters may be created.

In addition to the above, any number and desired arrangement of hook and loop fasteners, such as hook and loop fasteners 1040, may be included on base cone portion 104, cone collar extension 1004, and cone collar extension 1006. If hook and loop fasteners 1040 are included, a corresponding set of mating strips (not shown) may be situated on a reverse side of recovery cone collar 1002 for fastening shut recovery cone collar 1002.

It is noted that in one or more embodiments, cone collar extension 1004 and 1006 may include multiple layers, as discussed above, with respect to exterior textile layer 302, interface 304, cushioning layer 306, and interior textile layer 308. Further, neck piece 106 may include any of the elements described above in the present description in FIGS. 1-9.

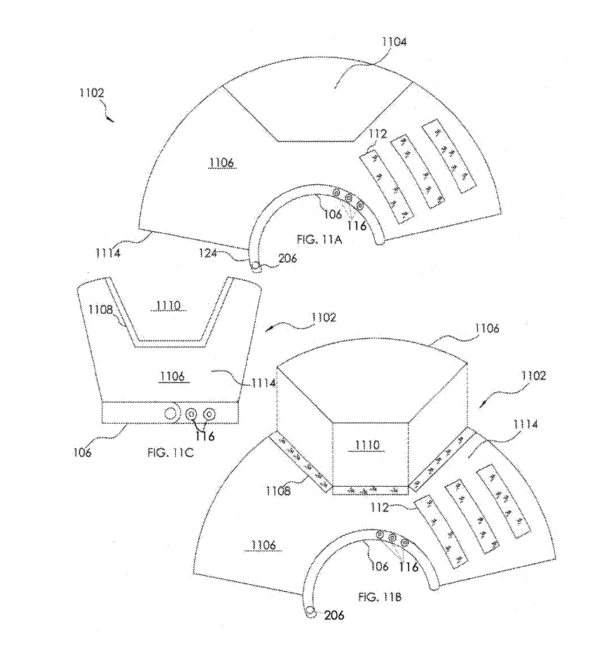

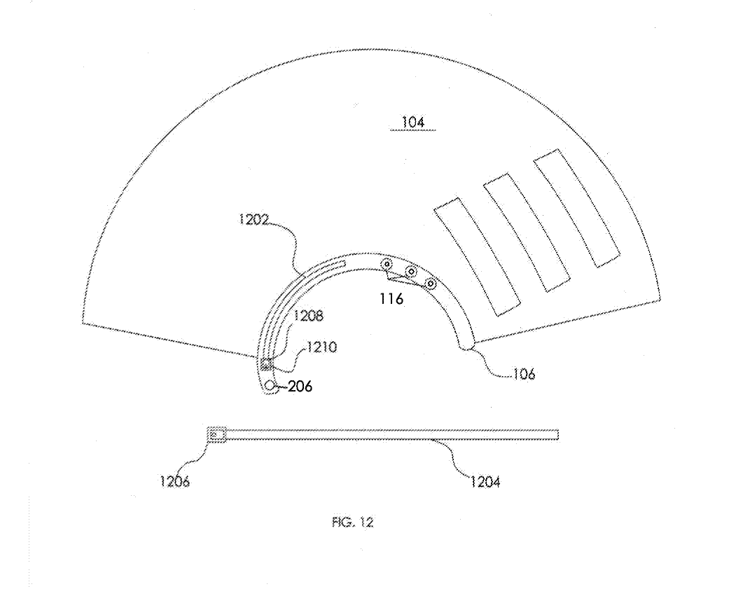

Turning to FIGS. 11A-11C, an alternative embodiment for a recovery cone collar is presented. Recovery cone collar 1102 may function as recovery cone collar 102, and may include a number of elements described above with respect to recovery cone collar 102 in FIGS. 1-8. Recovery cone collar 1102 may have an added advantage, whereby a removable panel, such as removable panel 1104 is included in one or more embodiments of recovery cone collar 1102.

FIG. 11A is an exterior view of recovery cone collar 1102. In one or more embodiments, recovery cone collar 1102 may include a cone portion, such as cone portion 1114 that is coupled to a neck piece, such as neck piece 106, as shown in FIGS. 11A-11C. Notably, neck piece 106 may include any of the elements described above with respect to neck piece 106 in FIGS. 1-10.

Removable panel 1104 may be detachable from the remaining body 1106 of the cone portion 1114. Further, the remaining body 1106 of recovery cone collar 1102 may include an aperture, such as aperture 1110. Aperture 1110 is defined by cone portion 1114. Aperture 1110 may be any shape or size to correspond to the shape and size of removable panel 1104.

In one or more exemplary embodiments, removable panel 1106 may be fastened to the remaining body 1106 of cone portion 1114 using a set of hook and loop fasteners, such as hook and loop fasteners 1108 (as shown in FIG. 11B). A set of hook and loop fasteners 1108 may be arranged on the body 1106 of recovery cone collar 1102 and beneath removable panel 1104. As shown in FIG. 11B, a set of three hook and loop fasteners 1108 have been arranged to surround a perimeter of aperture 1110 located on body 1106 of recovery cone collar 1102.

FIG. 11C shows an exterior view of recovery cone collar 1102 with the removable panel 1104 detached from body 1106 of recovery cone collar 1102. By removing removable panel 1104, a user of recovery cone collar 1102 is beneficially able to increase the visibility of an animal using recovery cone collar 1102, and may also provide greater comfort and sense of ease to the animal. Of course, a user may attach and detach removable panel 1104 as needed. Advantageously, a user may detach and reattach removable panel 1104 with minimal disturbance to an animal that may be wearing recovery cone collar 1102, such that a user may even detach or reattach removable panel 1104 while the animal is still wearing recovery cone collar 1102.

It is noted that alternative fasteners other than hook and loop fasteners 1108 may be used to remove and reattach removable panel 1104, including, but not limited to, a set of snaps, zippers, and/or buttons. In alternative embodiments, a greater number of panels, such as removable panel 1104 may be included with a recovery cone collar, such as recovery cone collar 1102, and may be formed of various shapes and sizes. Further, it is noted that recovery cone collar 102 as depicted in FIGS. 1-9 may include a removable panel, such as removable panel 1104 and operate in accordance with one or more embodiments described herein.

Turning to FIG. 12, FIG. 12 shows a recovery cone collar, such as recovery cone collar 102, which advantageously includes a light band and battery pack. Recovery cone collar 102 may include a number of elements, as discussed above, including cone portion 104 and neck piece 106. In addition, recovery cone collar 102, in one or more embodiments, may include an added light piece, such as light band 1204. Light band 1204 (also referred to as light rope) may be any type of light band known in the art. Light band 1204 may be lightweight and flexible, including being bendable. Light band 1204 may include at one of its end a battery pack, such as battery pack 1206, which may act as a power source for the one or more lights included with light band 1204. Light band 1204 may use any type of lights known in the art, including, but not limited to, light emitting diodes (LEDs). Further, the lights included in light band 1204 may provide a single, uniform color or may include multiple colors and have flashing features as well.

In one embodiment, a pocket, such as pocket 1202, may be sewn onto the exterior surface of neck piece 106. Additional fabric may be utilized to create pocket 1202. Thus, in one or more embodiments, pocket 1202 may be located over the outer textile layer 408 (as shown in FIG. 4) of neck piece 106 using this additional fabric (or any other suitable material). Pocket 1202 may be dimensioned to accommodate the size and length of light band 1204 and battery pack 1206. Pocket 1202 may extend along a portion of neck piece 106, and may terminate at one end ahead of the designated area on neck piece for fasteners 116.

In one or more embodiments, light band 1204 may be inserted into pocket 1202, such that battery pack 1206 is the last part of light band 1204 to enter pocket 1202. Battery pack 1206 may be tucked into the terminal end 1210 of pocket 1202, which is dimensioned to accommodate the size and shape of battery pack 1206. The end of pocket 1202 may be secured using an extra layer of fabric that tucks in place, or using one or more fasteners, VELCRO, or other securing means. Additionally, there may be small opening or hole, such as opening 1208, where a user may select a power button included on a top surface of battery pack 1206.

Accordingly, when activated, light band 1204 may emit light that will be reflected through the outer fabric or textile 408 of neck piece 106. According to one or more embodiments, having a light band, such as light band 1204 as part of recovery cone collar 102 provides added illumination that may be useful for a pet owner at night when walking or engaged in another activity while in the dark.

In alternative embodiments, a pocket (not shown) may be formed over exterior textile layer 302 of cone portion 104 in order for a light band, such as light band 1204 to be located therein. In such an embodiment, a zipper or VELCRO (or any other type of fastener, adhesive, or attachment means) may be used to secure the end of the pocket formed over the exterior textile layer 302 of cone portion 104. Accordingly, recovery cone collar 102 may be fitted with lights that give added illumination when needed. Further, such embodiments may also be a festive variation of an animal medical collar, particularly around holidays and celebrations, such as Christmas, New Years, birthdays, etc.

A number of additional elements may be included with any of the recovery cone collars presented above. For example, in one embodiment, the cone portion of any of the recovery cone collars may have scalloped edges. In yet another embodiment, additional fabric may be attachable (e.g. via VELCRO or other fasteners) to the exterior of the recovery cone collars, such that recovery cone collar may appear to include a cape. Such an embodiment may make a recovery cone collar, in accordance with any of the embodiments described herein, appear as a costume, (e.g. a “superhero” costume that includes a “superhero” cape) thus making such a recovery cone collar more entertaining and enjoyable for both the pet owner and the pet.

In yet another embodiment, the cone portion or body of a recovery cone collar, in accordance with any of the embodiments described above, may include one or more transparent or mesh windows. Advantageously, having such a transparent or mesh window may give an animal a greater sense of comfort and may make wearing the recovery cone collar less restrictive to the vision of an animal.

A number of embodiments for various recovery cone collars have been provided herein that offer a great deal of advantages not present in existing animal medical collars. For example, as described above, one or more recovery cone collars may include a padded neck piece that further includes a stretchable elastic band, and a number of snaps that make placing, wearing, and removing an attached cone collar much easier, and provide greater comfort to the animal. In addition, one or more recovery cone collars, as described herein, may include multiple layers, that form a stable, firm cone shape when the cone portion is fastened, but still include an additional cushioning layer to provide greater comfort and flexibility for the animal.

In addition to the above, the cone portion and the neck piece may be independently tightened and sized to accommodate the various sizes and dimensions of the intended animal wearer. As noted above, further embodiments of recovery cone collars may include detachable neck pieces that may be changed as needed by a pet owner or other user. In addition, recovery cone collars may include water absorbing beads that help to cool an animal in summer or hotter climates.

While preferred and alternate embodiments have been illustrated and described, as noted above, many changes can be made without departing from the spirit and scope of the present disclosure. Accordingly, the scope of the present disclosure is not limited by the disclosure of these preferred and alternate embodiments. Instead, the scope of the present disclosure may be determined entirely by reference to the claims. Insofar as the description above and the accompanying drawings disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C.§112¶6. In particular, the use of “step of” in the claims herein is not intended to invoke the provisions of U.S.C.§112¶6.

We claim:

1. A protective recovery cone collar for the head of an animal comprising:
a protective cone body with a first and a second opening, the first opening having a smaller size than the second opening, the protective cone body further comprising:
an exterior textile layer, an interfacing layer coupled to the exterior textile layer, a cushioning layer coupled to the interfacing layer, and an interior textile layer coupled to the interfacing layer.

2. The protective recovery cone collar of claim 1, wherein the exterior textile layer is fabric.

3. The protective recovery cone collar of claim 1, wherein, the interfacing layer is a heavy weight, ultra-firm stabilizer.

4. The protective recovery cone collar of claim 1, wherein the interfacing layer is PELLON 72F.

5. The protective recovery cone collar of claim 1, wherein the cushioning layer is comprised of batting.

6. The protective recovery cone collar of claim 1, wherein an exterior side of the protective cone body includes a set of hook and loop fasteners arranged in a vertical orientation and an interior side of the protective cone body includes a set of hook and loop fasteners arranged in a horizontal orientation.

7. The protective recovery cone collar of claim 5, wherein the batting comprises extra loft batting.

8. The protective recovery cone collar of claim 1, wherein the cushioning layer comprises two layers of extra loft batting.

9. A protective recovery cone collar for the head of an animal comprising:
a protective cone body with a first and a second opening, the first opening having a smaller size than the second opening, the protective cone body further comprising:
an exterior textile layer an interfacing layer coupled to the exterior textile layer, a cushioning layer coupled to the interfacing layer, and an interior textile layer coupled to the interfacing layer; and
a neck piece attached to the protective cone body comprising an exterior fabric layer, an interior cushioning layer coupled to the exterior fabric layer, and an interior elastic layer within the interior cushioning layer.

10. The protective recovery cone collar of claim 9, further comprising separate sizing means on the protective cone body and the neck piece that are configured to allow the protective cone body and the neck piece to be sized independently.

11. The protective recovery cone collar of claim 9, wherein the separate sizing means on the protective cone body and the neck piece allow for three separate independent sizes.

12. The protective recovery cone collar of claim 9, wherein the exterior textile layer is fabric.

13. The protective recovery cone collar of claim 9, wherein the neck piece is removeably attached to the protective cone portion.

14. The protective recovery cone collar of claim 9, wherein the interfacing layer is PELLON 72F.

15. The protective recovery cone collar of claim 9, wherein the cushioning layer is comprised of batting.

16. The protective recovery cone collar of claim 9, wherein the neck piece is water and stain resistant.

17. The protective recovery cone collar of claim 9, wherein the cushioning layer is extra loft batting.

18. The protective recovery cone collar of claim 9, wherein the cushioning layer comprises two layers of extra loft batting.

19. A protective covering for the head of an animal comprising:
a protective cone body with a first and a second opening, the first opening having a smaller size than the second opening, the protective cone body further comprising:
an exterior textile layer, an interfacing layer coupled to the exterior textile layer, a cushioning layer coupled to the interfacing layer and an interior textile layer coupled to the interfacing layer;
a neck piece removably attached to the protective cone body comprising an exterior fabric layer, an interior cushioning layer coupled to the exterior fabric layer, an interior elastic layer within the interior cushioning layer; and
water absorbent beads that are located within the interior of the neck piece that are configured to absorb and then slowly release water.

20. The protective covering of claim 19, wherein:
the protective cone body and the protective cone collar further comprise separate sizing means that allow the protective cone body and the protective cone collar to be sized independently between three independent sizes;
the exterior textile layer is fabric;
the interfacing layer is PELLON 72F;
the cushioning layer is extra loft batting;
the collar is water and stain resistant.
